(19) United States
(12) Patent Application Publication
(10) Pub. No.: US 2006/0062374 A1
(43) Pub. Date: Mar. 23, 2006

(54) Method and system for automatically assigning a customer call to an agent

(76) Inventor: Ajay Gupta, Bangalore (IN)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/943,604

(22) Filed: Sep. 17, 2004

(51) Int. Cl. H04M 3/00; H04M 5/00

(52) U.S. Cl. 379/265.06; 379/265.13

(57) ABSTRACT

Systems and methods for automatically assigning a customer call to one of a plurality of agents in customer contact center. The method includes receiving a customer call for assistance, the customer call comprising one or more customer parameters. Next, the calling customer is matched with one of the plurality of agents based upon the correlation of customer and agent parameters. Next, a customer-agent session is conducted, during which the agent attempts to provide the requested assistance to the customer. The customer is interviewed contemporaneously with (i.e., during or immediately thereafter) the customer-agent session to obtain customer feedback data. Subsequently, the agent's profile is updated with the customer feedback data, whereby the updated agent's profile is selectable for correlation to the customer parameters of a subsequently received customer call for a potential match therewith.

### FIELD OF THE INVENTION

The present invention relates generally to customer contact centers and their method of operation, and more particularly to a method and system for automatically assigning a customer call to an agent.

### BACKGROUND

Customer contact centers provide an important interface for customers/partners of an organization to contact the organization. The contact can be for a purpose of a query, trouble reporting, service request etc. The contact mechanism in a typical call centre is via a telephone, but it could be via a number of other electronic channels, including e-mail, etc.

When a call lands at a contact centre (which can be physically distributed, i.e. the agents may or may not be on a single physical location), it important to route the call to an appropriate call agent, and also to measure the performance of the call agents on the basis of calls handled per unit of time, and call escalations, i.e. if the call needed to routed to another agent with a different set of skills.

FIG. 1 illustrates a simplified block diagram showing the process flow for assigning a customer call to an agent as conventionally known in a voice oriented call center. A customer 102 initiates contact with the call center via an interactive voice response system 104. The customer provides one or more customer parameters, such as a customer identifier, which is subsequently supplied to an automated call distribution (ACD) system 106. The ACD system 106 also receives agent parameters from an agent profile database 108, and compares the customer and agent parameters to determine which of the agents is best suited to handle the incoming call. Once the comparison has identified the best available agent 110 to handle the call, it is routed from the ACD system to the best available agent 110.

In the conventional system 100, calls are distributed based on static attributes of the caller (e.g. customer identifier), type of problem (typically obtained by prompting the caller to interact with the IVR system) and capability profile of the agents. Currently the only dynamic attributes used in agent selection are traffic parameters such as load on an agent, time of day etc. The call assignment process is not informed by prior experiences the same or similar customers had with the same or similar agents. Further, there is no attempt to collect data upon the successful conclusion of the transaction or if the manner in which the transaction was completed was satisfactory to the customer. As organizations strive to become more customer-centric, customer call centers need to employ these and other aspects of customer feedback in the call assignment process to become more adaptive to changing customer needs and organizational strengths.

### SUMMARY

In an embodiment, a method of the present invention includes initially receiving a customer call for assistance (e.g., via telephone, the Internet, or another communication medium), the customer call including one or more customer parameters, such as a customer identifier. Next, the calling customer is matched with one of the plurality of agents based upon the correlation of customer and agent parameters. Next, a customer-agent session is conducted, during which the agent attempts to provide the requested assistance to the customer. The customer is interviewed contemporaneously with (i.e., during, or immediately thereafter) the customer-agent session to obtain customer feedback data. Subsequently, the agent's profile is updated with the customer feedback data, whereby the updated agent's profile is selectable for correlation to the customer parameters of a subsequently received customer call for a potential match therewith.

### BRIEF DESCRIPTION OF THE DRAWINGS

These and other aspects of the invention will be better understood in view of the following drawings and detailed description of specific embodiments.

FIG. 1 illustrates a simplified block diagram showing the process flow for assigning a customer call to an agent as conventionally known.

FIG. 2A illustrates a simplified block diagram showing the process flow for assigning a customer call to an agent and updating the assigned agent's profile in accordance with an embodiment of the present invention.

FIG. 2B illustrates a method for assigning a call to an agent and updating the assigned agent's profile using the system of FIG. 2A in accordance with an embodiment of the present invention.

FIG. 3 illustrates a feedback record generated by the feedback module shown in FIG. 2A in accordance with an embodiment of the present invention.

FIG. 4 illustrates four tables of data arranged in accordance with an embodiment of the present invention.

FIG. 5 illustrates one embodiment of the process for matching the customer with an agent using the data arrangement of FIG. 4 in accordance with an embodiment of the present invention.

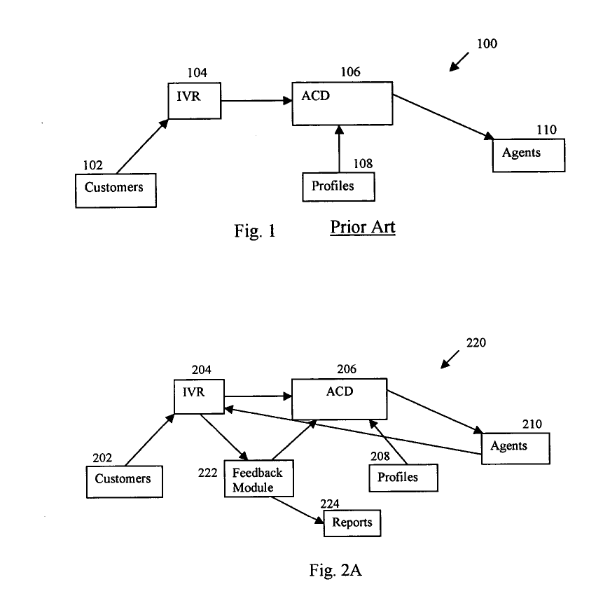

For clarity, previously identified features retain their original reference numerals throughout the specification.

### DETAILED DESCRIPTION

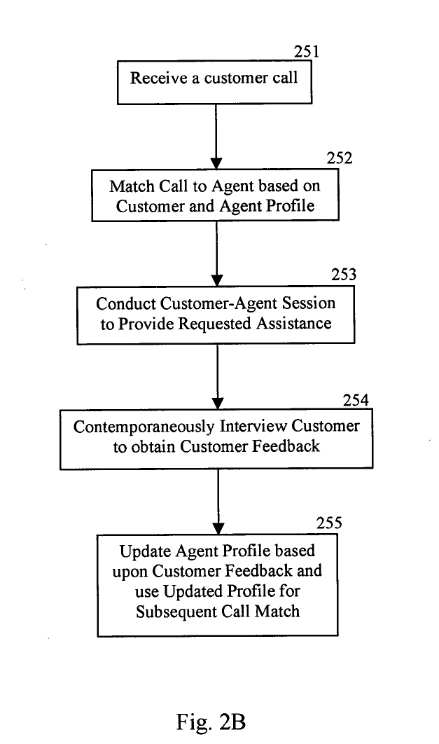

FIG. 2A illustrates a simplified block diagram showing the process flow for assigning a customer call to an agent and updating the assigned agent's profile in accordance with one embodiment. A customer 202 initiates contact with the call center via an interactive voice response system 204. The customer provides one or more customer parameters, such as a customer identifier, which is subsequently supplied to an automated call distribution (ACD) system 206. The ACD system 206 also receives agent parameters from an agent profile database 208, and compares the customer and agent parameters to determine which of the agents is best suited to handle the incoming call. Once the comparison has identified the best available agent 210 to handle the call, it is routed from the ACD system to the best available agent 210. The improved system 220 further includes a feedback module 222 which is operable to collect feedback data from the customer 202, and responsive thereto, update the assigned agent's profile. In addition, the feedback module 222 may provide reports 224 which summarize the obtained feedback data.

FIG. 2B illustrates a method for assigning a call to an agent and updating the agent's profile using the system of FIG. 2A. Initially at 252, the system 220 receives a customer call, the customer call containing one or more customer parameters. The customer parameters may include a customer identifier and/or other information (e.g., identification of a previous agent with whom a successful transaction was performed) which the system 220 automatically retrieves upon identifying the customer, as well as other information, such as a particular customer request or preference. As noted above, the customer call may be in the form any type of communication, for example, of a telephone or videophone call, an electronic communication sent via the World Wide Web (www) or Short Messaging System (SMS), an e-mail, and the like. In a particular embodiment, an interactive voice response system is used to provide the communication interface, although other communication systems may be used, for example an application server page, when contact is made via the www.

Next at 252, the customer parameters are supplied to the ACD system 106 and compared against agent parameters retrieved from the agent profile database 108, and therefrom a determination is made as to which agent is most suitable to take the incoming call. In a specific embodiment, the agent having agent parameters most closely correlated with the customer parameters is selected to take the call, those agents having less correlated parameters being chosen alternatively. However, any particular correlation (or alternatively, no correlation) may be used in assigning agents. For example, agents may be selected based upon their parameters being the least correlated to those of the customer for training or testing purposes.

Next at 253, the ACD system 106 routes the customer call to the selected agent, and a customer-agent session is conducted to attempt to provide the requested assistance to the customer. The session may be conducted via telephone, videophone, electronic communication (WWW, SMS, etc.) or any other mode of communication.

Contemporaneously with the customer-agent session, the customer is interviewed, whereby the customer supplies customer feedback data to the feedback module 222. As used herein the term “contemporaneously” refers to the timing of the interview as occurring either during the customer-client session (i.e., before it's conclusion), or immediately thereafter. It is however important that this feedback data is collected from the customer in such a manner that it is unbiased/uncorrupted, so for instance it is highly desirable that the feedback is collected without human intervention so that the customer is assured that the feedback data is not manipulated before the feedback data is entered in the system. In the illustrated embodiment of FIG. 2A, the customer 102 provides the feedback data to the feedback module 222 via the IVR module 104, although in alternative embodiments, another communication interface may be employed. Feedback may be obtained via various modalities including voice response, telephone keypad DTMF (dual tone multi-frequency) signals, ASR (Automatic Speech Recognition) signals, and the like and may comprise binary type entries (“yes” or “no”) for the customer's convenience, or may be graduated responses (numbers 1-5) to provide a richer data collection. In a particular embodiment, further described below, the customer feedback data is tagged with identifying information, such as a customer identifier, agent identifier, and transaction identifier, the identifying information and the customer feedback data collectively included within a customer feedback record. Next at 255, the customer feedback data (either as a part of a customer feedback record or independent thereof is supplied to the ACD 106 where the agent's profile is then updated, whereby the updated agent's profile is selectable for correlation with the customer parameters of a subsequently received customer call for a potential match therewith. In this manner, the agents' profiles are dynamically updated after every customer-agent session, and the system becomes increasingly efficient at routing customers calls to those agents who are most successful in handling calls of those particular types. In an alternative embodiment, the customer feedback data is supplied to the agent profile database 108, where the corresponding agent's profile is updated.

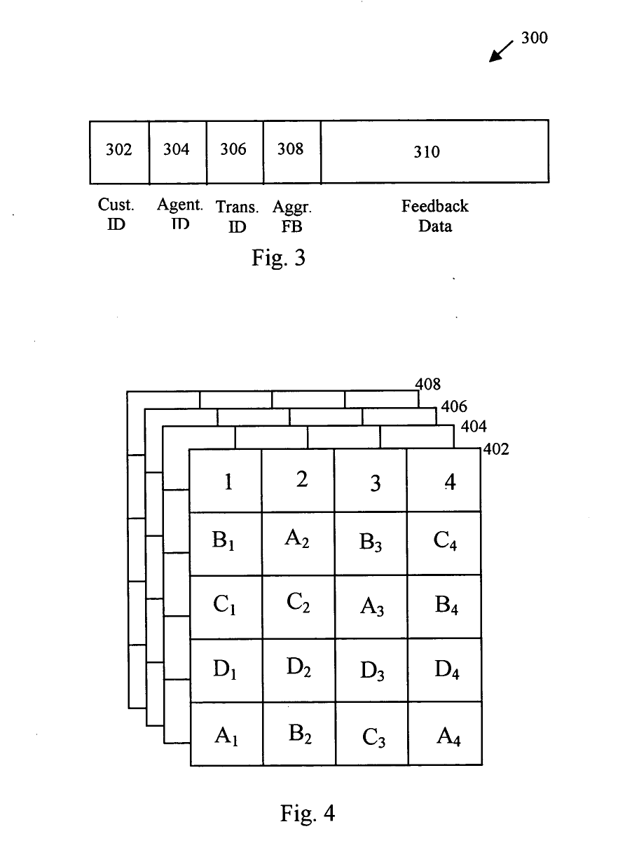

FIG. 3 illustrates one embodiment of a customer feedback record which is generated by the feedback module 222 and supplied to the ACD 106. The customer feedback record 300 includes a customer identifier 302, an agent identifier 304, a transaction identifier 306, an aggregate feedback score 308, and feedback data 310. The customer, agent, and transaction identifiers 302, 304, and 306 comprise identifying information of the calling customer, the selected agent, and the transaction, respectively. The aggregate feedback score 308 inlcudes a total score of all of the feedback data 310 provided. For example, the feedback data 310 may include a total of 4 questions, e.g., customer feedback on politeness, technical competence, timeliness, etc., each question weighted equally to sum to a collective score of 8 points, the actual sum being the aggregate feedback score 310. Of course, other computations can be used to compute the aggregate score.

The customer feedback data itself 310 includes the customer-supplied data responsive to the one or more inquiries made to the customer contemporaneously with the customer-agent session. The client feedback record 300 is supplied to the ACD 106 (or, alternatively to the agent profile database 108), where the feedback data 310 is used to update the corresponding agent's profile parameters. A new customer feedback record is generated for each customer-client session.

Data included within the customer feedback record 300 may also be organized in various ways to most efficiently select the best agent to handle the call. In one embodiment, data contained across all customer feedback records is arranged whereby (i) each customer is assigned to one of a plurality of customer-type categories, (ii) each agent is assigned to one or a plurality of agent-type categories, (iii) each transaction is assigned to one of a plurality of transaction-type categories, and (iv) each aggregate feedback score is assigned to one of a plurality of aggregate feedback store categories.

FIG. 4 illustrates four data tables containing data included within the customer feedback record 300 arranged in the manner described immediately above. Specifically, table 402 includes four customer-types categories 1-4, whereby each customer is categorized as being in one of the defined categories. Similarly, table 404 contains four different agent-types 1-4, each agent belonging to one of the categories, table 406 contains four different transaction types 1-4, each transaction belonging to one of the categories, and table 408 contains four different categories of aggregate feedback scores 1-4. One of ordinary skill in the art will readily appreciate that the different categories may include any delineation of the particular service provided. For example, the customer-type categories may include a premium-type, business-type, economy-type, and a prepaid-type. Alternatively, the customer-type may be based upon gender, demographics, geographic location, etc. Similarly, agent-types may include differing levels in skill area, location, language, or technical expertise. The categorization of agents and customers need not be static, as new attributes can be dynamically added and the populations regrouped which results in regrouping of the feedback data and its impact on routing. Transaction types may include different communications modalities, such as telephone, internet, SMS, or other. Aggregate feedback scores may be categorized by ranges e.g., 0-2, 2-4, 4-6, and 6-8.

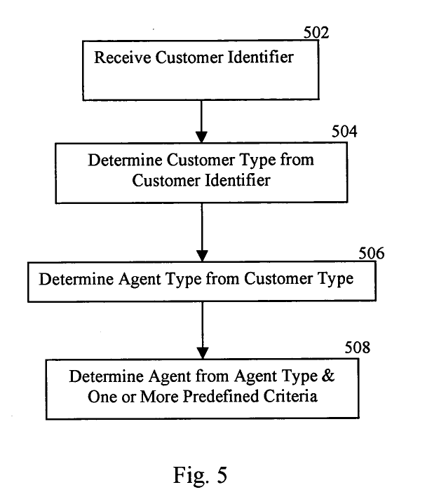

FIG. 5 illustrates one embodiment of the process for matching the customer with an agent using the data arrangement of FIG. 4 in accordance with one embodiment. Initially at 502, the customer identifier is received. In one embodiment, the customer identifier is included with the customer parameters supplied by the customer initially or retrieved by the system 200 by other processes.

Next at 504, the customer-type is determined from the particular customer identifier, as each customer is assigned to a customer-type according to the table 402 above. At 506, the agent-type is determined from the particular customer-type. In one embodiment, this determination is made by determining which of the agent-types (four in the illustrated embodiment) have the highest total aggregate score. In another embodiment, however, the agent-type having the lowest total aggregate feedback score may be selected for training or testing purposes. Other correlations are, of course, possible.

Once the agent-type is determined, the agent within the agent-type category can be determined (508) based upon one or more predefined criteria. For example, the predefined criteria may be selection of the agent having the highest aggregate feedback score, or the lowest score as noted above. One of ordinary skill in the art will readily appreciate that other 10 predefined criteria may be used in alternative embodiments.

Apart from using the online gathered feedback for automatic contact request distribution, the feedback module 222 can be used produced reports, at different levels of granularity, stating the customer and customer feedback data on specific agents, agent types, transactions, transaction types.

Such reports, when used together with additional information (which is gathered by agents, or the applications used by the agents) can be used to (i) proactively handle clients who have been dissatisfied with the result of the way they have been treated, (ii) provide performance feedback to agents, to determine their training needs and compensation, and (iii), when correlated with the transaction type, identify specific areas where the organization needs to invest in improving its business processes.

As readily appreciated by those skilled in the art, the described processes may be implemented in hardware, software, firmware or a combination of these implementations as appropriate. For example, the processes of communicating signals between the customer, agent and system may be carried out by telephone systems, computer networks, and the like. Further, some or all of the described processes may be implemented as computer readable instruction code resident on a computer readable medium 30 (removable disk, volatile or non-volatile memory, embedded processors, etc.), the instruction code operable to program a computer of other such programmable device to carry out the intended functions.

The foregoing description has been presented for purposes of illustration and description. It is not intended to be exhaustive or to limit the invention to the precise form disclosed, and obviously many modifications and variations are possible in light of the disclosed teaching. The described embodiments were chosen in order to best explain the principles of the invention and its practical application to thereby enable others skilled in the art to best utilize the invention in various embodiments and with various modifications as are suited to the particular use contemplated. It is intended that the scope of the invention be defined by the claims appended hereto.

What is claimed is:

1. A method for assigning a customer call to an agent, comprising:
receiving the customer call, the customer call comprising one or more customer parameters;
matching, based upon a correlation of customer and agent parameters, the customer with one of a plurality of agents;
conducting a customer-agent session, during which the one of a plurality of agents attempts to provide assistance to the customer;
interviewing the customer contemporaneously with the customer-agent session to obtain customer feedback data; and
updating a profile associated with the one of a plurality of agents with the customer feedback data, whereby the profile is selectable for correlation with customer parameters of a subsequently received customer call based on a potential match therewith.

2. The method of claim 1, wherein interviewing the customer contemporaneously with the customer-agent session comprises interviewing the customer during the customer-agent session.

3. The method of claim 1, wherein interviewing the customer contemporaneously with the customer-agent session comprises interviewing the customer immediately after the customer-agent session to obtain feedback data.

4. The method of claim 2, wherein interviewing comprises:
directing the call to an Interactive Voice Response system;
posing questions to the customer; and
receiving, for one or more questions posed, customer feedback data comprising a DTMF signal entry by at least one of a telephone keypad, an ASR signal or voice recognition signals.

5. The method of claim 1, wherein the customer feedback data is included within a feedback record, the feedback record further comprising a customer identifier, an agent identifier, and a transaction identifier.

6. The method of claim 5, further comprising computing an aggregate feedback score computed from the customer feedback data in the feedback record, wherein the aggregate feedback score is included within the feedback record.

7. The method of claim 6,
wherein the customer identifier of each feedback record is categorized into one of a plurality of customer-type categories, the transaction identifier of each feedback record is categorized into one of a plurality of transaction-type categories, the agent identifier of each feedback record is categorized into one of a plurality of agent-type categories, and the aggregate feedback score of each feedback record is categorized into one of a plurality of aggregate feedback scores, and
wherein matching the customer with one of the plurality of agents comprises:
determining, from the customer identifier, the corresponding customer-type;
determining, from the customer-type, the corresponding agent-type; and
determining, from the agent type and one or more predefined criteria, the agent who is to be matched with the customer.

8. The method of claim 7, wherein the predefined criteria is a highest aggregate feedback score within the same agent-type category.

9. The method of claim 6, wherein the predefined criteria is a lowest aggregate feedback score within the same agent-type category.

10. A system automatically assigning a customer call to one of a plurality of agents the system comprising:
a communication interface for receiving the customer call, the customer call comprising one or more customer parameters;
an automated call distribution system coupled to the communication interface, the automated call distribution system configured to receive the one or more customer parameters, and to match, based upon a correlation of customer and agent parameters, the customer with one of a plurality of agents; and
a feedback module coupled to the communication interface and to the automated call distribution system, the feedback module configured to receive, contemporaneously with the customer-agent session, customer feedback data, and in response, update a profile associated with the one of a plurality of agents with the customer feedback data, whereby the profile is selectable for correlation with the customer parameters of a subsequently received customer call based on a potential match therewith.

11. The system of claim 10, wherein the communication interface comprises:
an Interactive Voice Response system; and
means for receiving a DTMF signal entry by at least one of a telephone keypad, an ASR signal or voice recognition signals.

12. The system of claim 10, wherein the customer feedback data is included within a feedback record, the feedback record further comprises a customer identifier, an agent identifier, and a transaction identifier.

13. The system of claim 12, further comprising means for computing an aggregate feedback score computed from the customer feedback data in the feedback record, wherein the aggregate feedback score is included within the feedback record.

14. The system of claim 13,
wherein the customer identifier of each feedback record is categorized into one of a plurality of customer-type categories, the transaction identifier of each feedback record is categorized into one of a plurality of transaction-type categories, the agent identifier of each feedback record is categorized into one of a plurality of agent-type categories, and the aggregate feedback score of each feedback record is categorized into one of a plurality of aggregate feedback scores, and
wherein the automated call distribution module comprises:
means for determining, from the customer identifier, the corresponding customer-type;
means for determining, from the customer-type, the corresponding agent-type; and
means for determining, from the agent type and one or more predefined criteria, the agent who is to be matched with the customer.

15. The system of claim 14, wherein the predefined criteria is the highest aggregate feedback score within the same agent-type category.

16. The system of claim 14, wherein the predefined criteria is the lowest aggregate feedback score within the same agent-type category.

17. A computer program product, resident on a computer readable medium, operable to execute instructions for automatically assigning a customer call to one of a plurality of agents, the computer program product comprising:
instruction code to receive the customer call, the customer call comprising one or more customer parameters;
instruction code to match, based upon a correlation of customer and agent parameters, the customer call with one of a plurality of agents, whereby the one of a plurality of agents conducts a customer-agent session, during which the one of a plurality of agents attempts to provide assistance to a customer associated with the customer call, and whereby the customer is interviewed contemporaneously with the customer-agent session to obtain customer feedback data; and
instruction code to update a profile associated with the one of a plurality of agents with the customer feedback data, whereby the profile is selectable for correlation with the customer parameters of a subsequently received customer call based on a potential match therewith.

18. The computer program product of claim 17, wherein the customer feedback data is included within a feedback record, the feedback record further comprises a customer identifier, an agent identifier, and a transaction identifier.

19. The computer program product of claim 18, further comprising instruction code to compute an aggregate feedback score computed from the customer feedback data in the feedback record, wherein the aggregate feedback score is included within the feedback record.

20. The computer program product of claim 19,
wherein the customer identifier of each feedback record is categorized into one of a plurality of customer-type categories, the transaction identifier of each feedback record is categorized into one of a plurality of transaction-type categories, the agent identifier of each feedback record is categorized into one of a plurality of agent-type categories, and the aggregate feedback score of each feedback record is categorized into one of a plurality of aggregate feedback scores, and
wherein the instruction code to match the customer with one of the plurality of agents comprises:
instruction code to determine, from the customer identifier, the corresponding customer-type;
instruction code to determine, from the customer-type, the corresponding agent-type; and
instruction code to determine, from the agent type and one or more predefined criteria, the agent who is to be matched with the customer.

21. The computer program product of claim 20, wherein the predefined criteria is a highest aggregate feedback score within the same agent-type category.

22. The computer program product of claim 20, wherein the predefined criteria is a lowest aggregate feedback score within the same agent-type category.
